(19) United States
(12) Patent Application Publication
(10) Pub. No.: US 2009/0128473 A1
(43) Pub. Date: May 21, 2009

(54) ACTIVE MATRIX DISPLAY DEVICES

(75) Inventors: Keitaro YAMASHITA, Kobe (JP); Keiichi Sano, Chu-Nan (TW); Masahiro Yoshiga, Kobe (JP)

Correspondence Address: VENABLE LLP, P.O. BOX 34385, WASHINGTON, DC, 20043-9998, US

(73) Assignee: TPO Displays Corp., Chu-Nan (TW)

(21) Appl. No.: 12/267,136

(22) Filed: Nov. 7, 2008

(30) Foreign Application Priority Data
Nov. 15, 2007 (JP) JP2007-296304

(51) Int. Cl. G09G 3/36

(52) U.S. Cl. 345/89

(57) ABSTRACT

Active matrix display devices capable of improving aperture ratio of pixels and of smoothing intermediate colors are presented. An active matrix display device has static random access memory (SRAM) devices and digital to analog converters (DAC), which are both allocated to each of sub-pixels divided by a pixel. The SRAM stores an input digital data with over two bits, which can be used as gradient information for gray scale display of the sub-pixels. The input digital data is converted into analog data for display by the DAC. Gray scale display of the sub-pixels can be performed based on gray scales determined by the analog data for display. The pixel can be used to display multiple gray scales according to combinations of areas and gray scales of the sub-pixels.

### CROSS REFERENCE TO RELATED APPLICATIONS

This application claims the benefit of Japanese Patent Application No. 2007-296304 filed on Nov. 15, 2007, which is incorporated herein by reference.

### BACKGROUND OF THE INVENTION

1. Field of the Invention

The invention relates to active matrix display devices with pluralities of pixels arranged with an array in which each pixel is divided into different areas of arrays of sub-pixels, and more particularly to display devices with high aperture ratio and exhibiting smooth intermediate colors.

2. Description of the Related Art

Among the prior arts, active matrix liquid crystal display devices with pluralities of pixels arranged with an array are well-known to persons skilled in the arts. In the liquid crystal display devices, a pixel can be divided into pluralities of sub-pixels. Multiple order levels of gray scales can be thus achieved in according with combinations of areas of each sub-pixel referring to Patent Reference 1.

Patent Reference 1: Japanese Patent Laid-open No. 2005-300579 (FIGS. 5-13, and pages 2-9).

FIG. 7 is a schematic view of the shape and arrangement of a conventional sub-pixel 3p. For example, as shown in FIG. 7, in a conventional liquid crystal display device, a pixel 2p can be divided into four sub-pixels 3p. Each sub-pixel 3p can display black or white. The area ratio of the four sub-pixels 3p is set as 1:2:4:8. Among the sub-pixels 3p, however, boundary regions 4p have to be set for wiring of the liquid crystal display device. More specifically, among the sub-pixels 3p, non-active optical regions are formed. In the conventional liquid crystal display device, multiple order levels of gray scales can be thus achieved and proceeded by displaying black or white of different areas of the four sub-pixels 3p and by combinations of areas of sub-pixels 3p.

Among the conventional liquid crystal display devices, however, structural boundary regions 4P (optically non-active regions) are respectively formed among the four sub-pixels 3P. For example, in FIG. 7, three boundary regions 4P (optically non-active regions) are formed in the pixel 2P. Merely the portion can cause reduction of aperture ratio of the pixel 2P. Therefore, reducing the numerals of the sub-pixels 3P is considered to increase the aperture ratio of the pixel 2P. In this situation, however, the numbers of area combination of the sub-pixels 3P are reduced, resulting in reduction of order levels of the pixel 2P.

In addition, among the conventional liquid crystal display devices, since each sub-pixels 3P displays two states (one bit) of black and white, smoothly expression of intermediate color between black and white is limited thereto. For example, once the scale of the liquid crystal display device is enlarged, roughly expression of intermediate color between black and white becomes very apparently.

### BRIEF SUMMARY OF THE INVENTION

According to the abovementioned issues, the invention provides active matrix display devices with high aperture ratio and capable of exhibiting smooth intermediate colors.

The active matrix display device of the invention includes: a plurality of pixels arranged as an array, each the pixels divided into different areas of a plurality of sub-pixels; a multi-bit memories respectively disposed in the sub-pixels to memorize an input digital data with over two bits to served as an gray gradient information for displaying gray scale of each the sub-pixels; a digital to analog converter circuit for converting the input digital data memorized in the multi-bit memories to an analog data for displaying gray scale of each the sub-pixels; and a display element for displaying gray scale of each the sub-pixels in accordance with the analog data converted by the digital to analog converter circuit.

According to the abovementioned display device, displaying of sub-pixel gray scale can be proceeded in accordance with varies levels of analogue data. That is, compared with the prior arts which can merely display black or white in a sub-pixel, the display devices of the invention can display various intermediate colors. Under this circumstance, displaying multiple order levels of gray scales can be proceeded by constructing combinations of sub-pixel areas and order levels in one pixel. Compared with the prior arts, the display device of the invention has fewer sub-pixels, but can display the same or even better multiple order levels of gray scales. Consequently, since the number of sub-pixels in one pixel can be reduced, the boundary regions (optically non-active regions) among the sub-pixels can be reduced, thereby improving aperture ratio of the pixel. Further, since each sub-pixel can display various intermediate colors, smoothly intermediate color expression can be presented compared to the prior arts.

Electronic apparatuses of the invention comprise the abovementioned active matrix display devices.

Intermediate Display circuits of the invention for an active matrix display device with a plurality of pixels arranged as an array, each pixel divided into different areas of a plurality of sub-pixels, comprising: a multi-bit memory disposed in each the sub-pixels to memorize an input digital data with at over two bits to served as an gray gradient information for displaying gray scale of each the sub-pixels; and a digital to analog converter circuit to converting the input digital data memorized in the multi-bit memory to an analog data for displaying gray scale of each the sub-pixels.

According to the display circuits of the invention, gray scales of sub-pixels can be displayed in accordance with varied order levels of display analogue data. Consequently, constructed boundary regions (optically non-active regions) among sub-pixels can be reduced, thereby improving aperture ratio of the pixel. Further, since each sub-pixel can display various intermediate colors, smoothly intermediate color expression can be presented compared with the prior arts.

Methods of displaying images of the invention for an active matrix display device with a plurality of pixels arranged as an array, each pixel divided into different areas of a plurality of sub-pixels, comprising: inputting an input digital data with at over two bits to serve as an gray gradient information for displaying gray scale of each the sub-pixels; converting the input digital data to analog data for displaying gray scale of each the sub-pixels; and displaying gray scale of each sub-pixel in accordance with the analog data determining gray scales of each the sub-pixels.

According to the displaying methods of the invention, gray scales of sub-pixels can be displayed in accordance with varied order levels of display analogue data. Consequently, constructed boundary regions (optically non-active regions) among sub-pixels can be reduced, thereby improving aperture ratio of the pixel. Further, since each sub-pixel can display various intermediate colors, smoothly intermediate color expression can be presented compared with the prior arts.

According to the invention, by disposing multi-bit memories and digital analogue circuits in the sub-pixels, aperture ratio of the pixel can be improved and intermediate colors can be smoothly expressed.

### BRIEF DESCRIPTION OF THE DRAWINGS

The invention can be more fully understood by reading the subsequent detailed description and examples with references made to the accompanying drawings, wherein:

FIG. 1 is a schematic view of the construction of the liquid crystal display device 1;

FIG. 2 is a schematic view of an embodiment of a display circuit 8 of the liquid crystal device 1 of the invention;

FIG. 3 shows relationship chart between brightness and order level of the sub-pixel 3;

FIG. 4 is schematic view of an embodiment of gray gradient displaying of the pixel 2 of the invention;

FIG. 5 shows relationship chart between brightness and order level of the pixel 2;

FIG. 6a and FIG. 6b show other embodiments of the shape and location of the sub-pixels 3; and

FIG. 7 is a schematic view of the shape and arrangement of a conventional sub-pixel 3P.

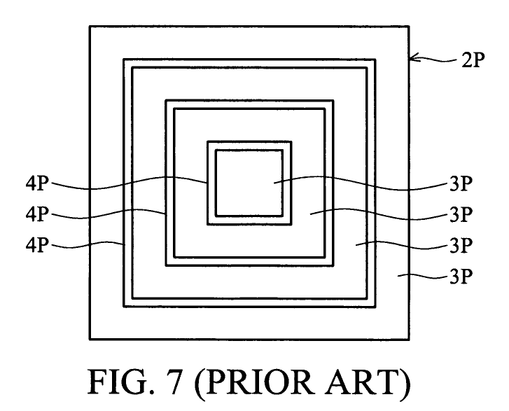

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims. In this embodiment, liquid crystal display panels for electronic apparatuses, such as mobile phones, digital cameras, personal digital assistances (PDA), personal computers, televisions, car displays, aviation displays, digital photo frames, or portable DVD players, are exemplified. The liquid crystal display panels are active matrix liquid crystal display devices with an array of pixels.

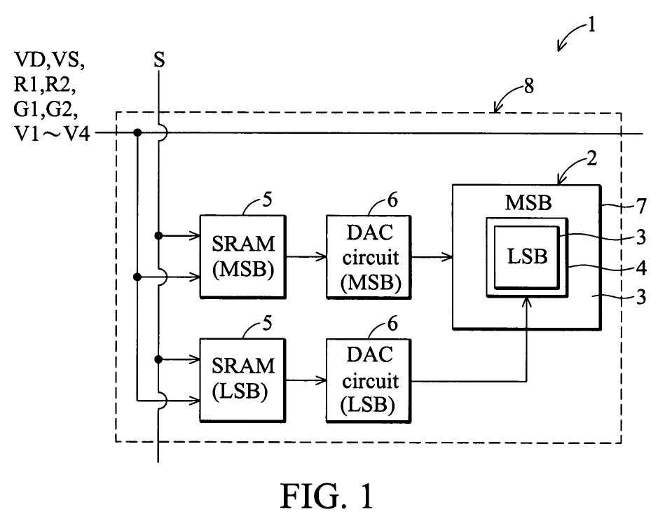

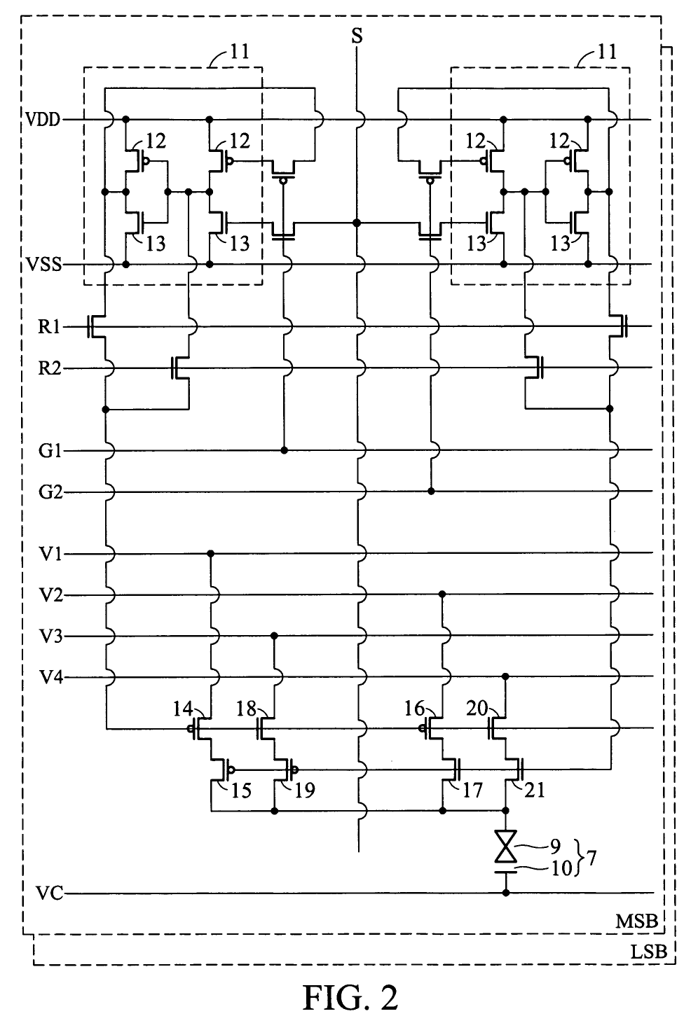

FIG. 1 and FIG. 2 illustrate constructions of the liquid crystal display devices according to the embodiments of the invention. Referring to FIG. 1, a construction of a liquid crystal display device is schematically illustrated.

FIG. 1 is a schematic view of the construction of the liquid crystal display device 1. As shown in FIG. 1, in the liquid crystal display device 1 of the embodiment, each of pluralities pixels is divided into two sub-pixels 3 of a most significant bit (MSB) and a least significant bit (LSB). The liquid crystal display device 1 includes a statistic random access memory (SRAM) 5 disposed in each sub-pixel 3, a Digital-to-Analog Converter (DAC) circuit 6 disposed in each sub-pixel 3, and a liquid crystal display element 7 for displaying gray scales of each sub-pixel 3. Under this circumstance, a display circuit 8 of the sub-pixels 3 alternatively includes the SRAM 5 and the DAC circuit 6.

As shown in FIG. 1, the shape of the LSB sub-pixel 3 is a square. The shape of the MSB sub-pixel 3 is surrounding the LSB sub-pixel 3. That is, the outer rim of the MSB sub-pixel 3 is a square. Boundary regions 4 (optically non-active regions) constructed between the two sub-pixels 3 are used for wiring of the liquid crystal display element 7. The area ratio between the LSB sub-pixel 3 and the MSB sub-pixel 3 is set to 1:4. Here, the LSB sub-pixel 3 is equivalent to the first sub-pixel of the invention and the MSB sub-pixel 3 is equivalent to the second sub-pixel of the invention.

Within the SRAM 5 of each sub-pixel 3, input binary digital signals, such as “00”, “01”, “10”, “11” and the likes, inputted from source lines are memorized. According to the input digital signals, gray scales of four order levels can be displayed by using each sub-pixel 3. Therefore, the input digital signals can also be used for the order level information of each sub-pixel 3.

Within DAC circuit 6 of each sub-pixel 3, the input digital signals memorized by the SRAM 5 are converted into displaying analogue signals for displaying gray scales of each sub-pixels 3. Specifically, the binary input digital signals are converted into four analogue voltages (V1, V2, V3, and V4) applied on the pixel electrode 9 of each sub-pixels 3.

The liquid crystal display element 7 of each sub-pixels 3 includes a pixel electrode 9 and a counter electrode 10, thereby displaying gray scales in accordance with order levels of the displaying analogue signals. In this liquid crystal display element 7, four order levels of gray orders are displayed in accordance with four analogue voltages (V1, V2, V3, and V4) transformed by the DAC circuit 6.

Besides, the liquid crystal display element 7 of each sub-pixels 3 includes reflective part (not shown) for reflecting ambient lights. That is, the liquid crystal display element 7 can be a reflective liquid crystal display element.

Next, referring to FIG. 2, specific construction of a display circuit 8 of the liquid crystal device 1 is illustrated.

FIG. 2 is a schematic view of an embodiment of a display circuit 8 of the liquid crystal device 1 of the invention. Moreover, in FIG. 2, although only one of the two sub-pixels 3 (MSB sub-pixel 3) is depicted in order to facilitate description, the construction of the other (MSB sub-pixel 3) of the display circuit 8 is the same.

First, the SRAM 5 of the sub-pixel 3 is disclosed. As shown in FIG. 2, the SRAM 5 of the sub-pixel 3 comprises two hold circuits 11. The hold circuits 11 include inverter circuits in series with a PMOS transistor 12 and an NMOS transistor 13. The two inverter circuits are positive feedback. As shown in FIG. 2, voltages VDD and VSS for driving the hold circuits 11 are applied on the hold circuits 11 of the sub-pixel 3. Once the gates G1 and G2 are applied on high voltages, an input digital data of binary form source lines are input, and the input digital data are hold in each hold circuit one by one.

For example, when the gate G1 is applied on high voltage, a high level data(such as “1”) of the input digital data of binary (such as “10”) is held in the first hold circuit 11 (the hold circuit 11 on the left of FIG. 2); when the gate G2 is applied on high voltage, a low level data (such as “0”) of the input digital data of binary (such as “10”) is held in the second hold circuit 11 (the hold circuit 11 on the right of FIG. 2).

Next, the DAC 6 of the sub-pixel 3 is disclosed. As shown in FIG. 2, the DAC 6 of the sub-pixel 3 comprises two PMOS transistors 14 and 15, which connected to supply lines of an analogue voltage V1, a PMOS transistor 16 and an NMOS transistor 17, which connected to supply lines of an analogue voltage V2, an NMOS transistor 18 and a PMOS transistor 19, which connected to supply lines of an analogue voltage, and two NMOS transistors 20 and 21, which connected to supply lines of an analogue voltage V4.

The gates of the two PMOS transistors 14 and 15 are received the signal from respective two hold circuits 11, wherein the two PMOS transistors 14 and 15 are connected to supply lines of the analogue voltage V1. Moreover, when a “00” signal is output from the two hold circuits 11 (the “0” signal from the first sustained circuit 11, the “0” signal from the second sustained circuit 11), these two PMOS transistors 14 and 15 are turned on such that the analogue voltage V1 is supplied to pixel electrode 9.

Besides, The gates of the PMOS transistors 16 and the NMOS transistor 17 are received the signal from respective two hold circuits 11, wherein the PMOS transistors 16 and the NMOS transistor 17 are connected to supply lines of the analogue voltage V2. Moreover, when a “01” signal is output from the two hold circuits 11 (the “0” signal from the first sustained circuit 11, the “1” signal from the second sustained circuit 11), the PMOS transistor 16 and the NMOS transistor 17 are turned on such that the analogue voltage V2 is supplied to pixel electrode 9.

The gates of the NMOS transistors 18 and the PMOS transistor 19 are received the signal from respective two hold circuits 11, wherein the NMOS transistors 18 and the PMOS transistor 19 are connected to supply lines of the analogue voltage V3. Moreover, when a “10” signal is output from the two hold circuits 11 (the “1” signal from the first hold circuit 11, the “0” signal from the second hold circuit 11), the NMOS transistor 18 and the PMOS transistor 19 are turned on such that the analogue voltage V3 is supplied to pixel electrode 9.

Besides, the gates of the two NMOS transistors 20 and 21 are received the signal from respective two hold circuits 11, wherein the two NMOS transistors 20 and 21 are connected to supply lines of the analogue voltage V4. Moreover, when an “11” signal is output from the two hold circuits 11 (the “1” signal from the first hold circuit 11, the “1” signal from the second hold circuit 11), the two NMOS transistors 20 and 21 are turned on such that the analogue voltage V4 is supplied to pixel electrode 9.

Hereinafter, refreshment of the liquid crystal display element 7 is disclosed. As shown in FIG. 2, both the two inverter circuits in the hold circuit 11 are disposed on the signal lines for outputting digital data. Specifically, both the two inverter circuits are disposed on the signal lines for directly outputting the input digital data and on the signal lines for inverting and outputting the input digit data. When the refresh line R1 is applied on high voltage, the input digital data (such as “1”) is directly output as the original data (such as “1”). On the other hand, when the refresh line R2 is applied on high voltage, the input digital data (such as “1”) is output as the inverted data (such as “0”).

Therefore, the output signals from the two hold circuits 11 can be inverted by switching high voltages applied on the refresh lines R1 and R2. And the analogue voltages V1, V2, V3, and V4 applied on the pixel electrodes 9 can also be inverted. Moreover, the voltage VC applied on the counter electrode 10 and high voltages applied on the refresh lines R1 and R2 are simultaneously switched, refreshment of the liquid crystal display element 7 can be preceded. Under this circumstance, the power voltages of the SRAM 5 can be VDD=V1 and VSS=V4, and the output voltage range of the DAC circuit 6 become wider. In addition, the absolute values of the power voltages VDD and VSS can be reduced, and types of the required power voltages are also reduced.

The refreshment of the liquid crystal display element 7 can be proceed by other methods. For example, instead of phase exchanging of the input digital date of the DAC circuit 6, the liquid crystal display element 7 can be refreshed by inverting the analogue voltages V1, V2, V3, and V4 applied on the pixel electrodes 9. Specifically, the liquid crystal display element 7 can be refreshed by simultaneously exchanging the voltage VC applied on the counter electrode 10 and inverting the analogue voltages V1, V2, V3, and V4. Under this circumstance, refresh lines R1 and R2 and four TFTs for inverting connected digital data are unnecessary. Thus, the circuit scale of the display circuit 8 can be reduced.

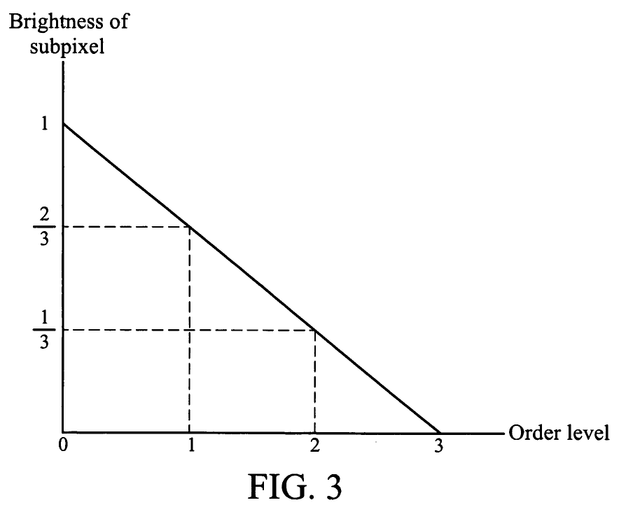

Next, referring to FIGS. 3-5, gray scale displaying of the pixel 2 is disclosed. First, gray scale displaying of the sub-pixel 3 is disclosed with depiction in FIG. 3. FIG. 3 shows a relationship chart of brightness and order level of the sub-pixel 3. As shown in FIG. four order levels “0-3” of gray scales can be displayed on the sub-pixel 3 in accordance with V1-V4. In the intermediate time, the brightness of the sub-pixel 3 is set linearly varied as changes of the order levels.

For example, as shown in FIG. 3, if the order level of the sub-pixel 3 is “0”, the brightness of the sub-pixel 3 is set as “1”. If the order level of the sub-pixel 3 is “3”, the brightness of the sub-pixel 3 is set as “0”. If the order level of the sub-pixel 3 is “1”, the brightness of the sub-pixel 3 is set as “2/3”. And if the order level of the sub-pixel 3 is “2”, the brightness of the sub-pixel 3 is set as “1/3”.

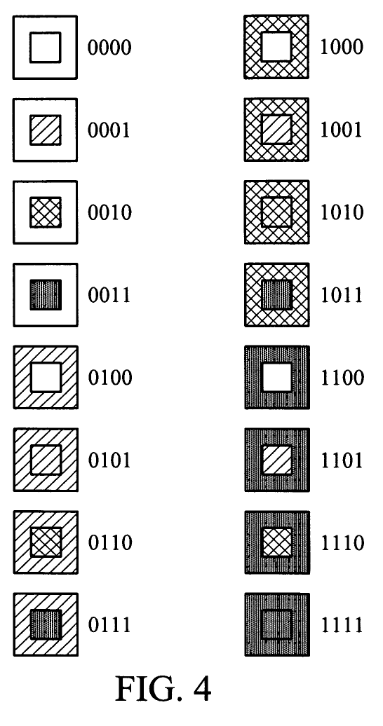

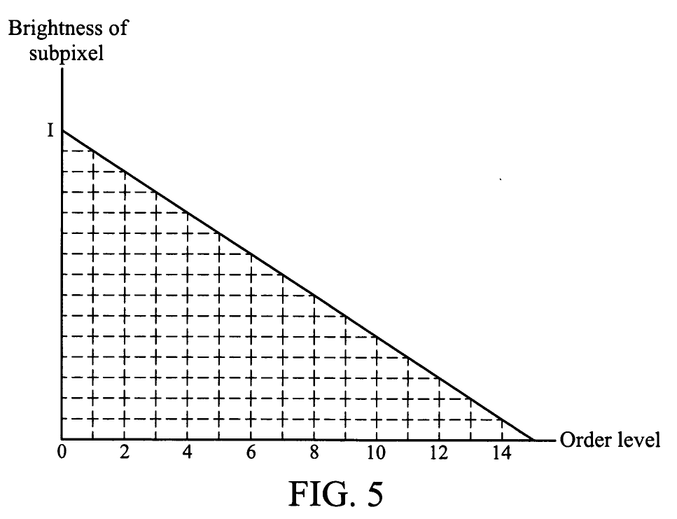

Next, gray scale displaying of the pixel 2 is disclosed with depiction in FIG. 4 and FIG. 5. FIG. 4 is schematic view of an embodiment of gray scale displaying of the pixel 2 of the invention; FIG. 5 shows relationship chart of brightness and order level of the pixel 2.

Referring to FIG. 4, gray scales for displaying sixteen order levels “0-15” on pixel 2 can be proceeded by combining different brightness of two sub-pixels 3 (i.e., the MSB sub-pixel 3 and the LSB sub-pixel 3). Also in FIG. 4, sixteen order levels of “0-15” can be expressed with binary codes “0000-1111”.

In this embodiment, the four bits binary codes and the four bits input data of the pixel 2 have the same contents. In the four bits input data (four number), the former two bits (former two number) are input digit data for the MSB sub-pixel, while the latter two bits (latter two number) are input digit data for the LSB sub-pixel.

For example, when the input digit data is “0011”, the input digit data for the MSB sub-pixel is “00” and input digit data for the LSB sub-pixel is “11”. Under this circumstance, the order level of the MSB sub-pixel 3 is “0” which is depicted as the brightest, while the order level of the LSB sub-pixel 3 is “0” which is depicted as the brightest, as shown in FIG. 4.

Referring to FIG. 5, brightness of the pixel 2 can be set by combinations of brightness of the sub-pixels 3, such that the brightness of pixel 2 will be linearly variation. For example, when the order level of the pixel 2 is “0”, the brightness of the sub-pixel 2 is depicted as “1”. When the order level of the pixel 2 is “15”, the brightness of the sub-pixel 2 is depicted as “0”. When order level of the pixel 2 is “n (n=0-15)”, the brightness of the sub-pixel 2 is depicted as “(15-n)/15”.

Moreover, in FIG. 3 to FIT.5, In view of the relationship between the order level and brightness, although the low order level is depicted as an example of bright, and although the high order level is depicted as an example of dark, the relationship between the order level and brightness can be reversed. Specifically, the low order level is depicted as dark, and although the high order level is depicted as bright.

According to the above-mentioned liquid crystal display device 1 of the embodiment, multi-bit memories and digital/analogue circuit can be disposed in sub-pixels 3, thereby improving aperture ratio of the pixel 2 and smoothly expressing the intermediate colors.

That is, in this embodiment, both the MSB and LSB sub-pixels can be displayed gray scales in accordance with four order levels analogue data. Specifically, compared with a prior art sub-pixel which only can display black or white, various intermediate colors can be displayed by the sub-pixel 3 of the embodiment of the invention. Under this circumstance, sixteen order levels of gray scales can be preceded by combining order level and area of the MSB and LSB sub-pixels 3. Therefore, by using fewer sub-pixels 3 compared with prior arts, the same or even better gray scale displaying can be achieved. For example, in order to present gray scales with sixteen order levels, four sub-pixels are required in prior arts. In the present embodiment, however, only two sub-pixels 3 is needed to present gray scales with sixteen order levels.

Accordingly, since numbers of the sub-pixels in a pixel 2 can be reduced, the area of boundary regions 4 (optically non-active regions) between each sub-pixels 3 is also reduced. In this embodiment, since merely two sub-pixels 3 is composed of a pixel 2, only one constructed boundary region 4 (optically non-active region) is formed between the two sub-pixels 3, thereby improving the aperture ratio of the pixels. Since each sub-pixel 3 can present several intermediate colors, moreover, intermediate colors can be smoothly expressed by comparison with prior arts.

Besides, in this embodiment, since an SRAM 5 can be used as the multi-bit memory in the sub-pixel 3, power consumption can thus be reduced. Furthermore, by disposing a memory in the pixel 2, each sub-pixel 3 can be driven using input digital data in the memory. The power consumption of the exterior devices (such as ICs) of the display device is suppressed during waiting periods.

Besides, in this embodiment, since variation of the combinations of order level and area of the MSB and LSB sub-pixels 3 are varied linearly with the brightness of the pixel 2, the intermediate colors can be smoothly expressed.

Besides, in this embodiment, the shape and location of the MSB and LSB sub-pixels 3 are symmetrically disposed in the center of the pixel 2. Thus, gravity center shift of the MSB and LSB sub-pixels 3 can be prevented, thereby inhibiting the occurred problems of false images on the display devices due to gravity center shift of the MSB and LSB sub-pixels 3.

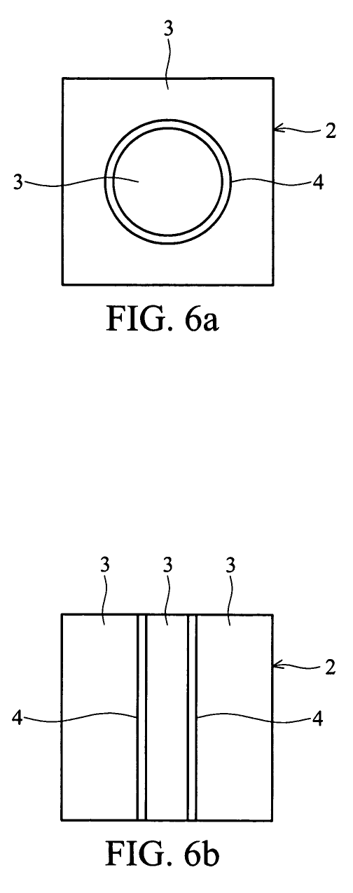

FIG. 6 shows other embodiments of the shape and location of the sub-pixels 3. Referring to FIG. 6(a), the shape of the LSB sub-pixel 3 can be a circular. Under this circumstance, the shape of the MSB sub-pixel 3 is surrounding the LSB sub-pixel 3. Both the centers of the MSB and LSB sub-pixels 3 are located the center of the pixel 2. Moreover, referring to FIG. 6(b), the shape of the LSB sub-pixel 3 can be linear. Under this circumstance, the shape of the MSB sub-pixel 3 is sandwiching the LSB sub-pixel 3. Both the centers of the MSB and LSB sub-pixels 3 are located the center of the pixel 2.

Besides, in this embodiment, since the reflective ambient light by a reflective portion can be used to display, power consumption can be reduced compared with the case using a back light source.

Although embodiments of the invention are described as examples, but are not limited thereto, the spirit of the invention can be applied to various modifications and similar arrangements in the scope of the claims.

For example, in the above-motioned embodiments, although the active matrix display devices 1 are described as examples, but are not limited thereto, other displays such as organic EL displays are also applicable. Besides, in the above-motioned embodiments, although the normally white type liquid crystal display devices (when an applied voltage is 0, the display devices are at “white state”) are described as examples, but are not limited thereto, the normally black type liquid crystal display devices (when an applied voltage is 0, the display devices are at “black state”) are also applicable.

Besides, in the above-motioned embodiments, although a pixel 2 with the two LSB and MSM sub-pixels are described as examples but are not limited thereto, other pixels with at least three sub-pixels are also applicable.

Besides, in the above-motioned embodiments, although a SRAM 5 which is served as the multi-bit memory is described as examples but is not limited thereto, a DRAM is also applicable. Once a DRAM is served as the multi-bit memory, circuit dimension of the memory can be reduced.

Besides, in the above-motioned embodiments, although an input digit data with binary digits in each sub-pixel 3 is described as examples but is not limited thereto, an input digital data with at least three digits is also applicable.

Besides, in the above-motioned embodiments, although the gray scales with four order levels on a sub-pixel 3 and the gray scales with sixteen order levels on a pixel 2 are described as examples but are not limited thereto, other gray scales with multiple order levels on the sub-pixel 3 or pixel 2 is also applicable.

Therefore, the active matrix display devices of the invention which are capable of improving aperture ratio and smoothly expressing the intermediate colors are applicable to liquid crystal display devices.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. An active matrix display device, comprising:
a plurality of pixels arranged as an array, each the pixels divided into different areas of a plurality of sub-pixels;
at least one multi-bit memory respectively disposed in the sub-pixels to memorize an input digital data with over two bits to served as an gray gradient information for displaying gray scale of each the sub-pixels;
a digital to analog converter circuit for converting the input digital data memorized in the multi-bit memory to an analog data for displaying gray scale of each the sub-pixels; and
a display element for displaying gray scale of each the sub-pixels in accordance with the analog data converted by the digital to analog converter circuit.

2. The active matrix display device as claimed in claim 1, wherein the multi-bit memory comprises static random access memory (SRAM) or dynamic random access memory (DRAM).

3. The active matrix display device as claimed in claim 1, wherein the sub-pixels comprises plurality of gray scales varied linearly with the brightness of each the sub-pixels, and the area ratio of each the sub-pixels is a combination according to different brightness of each sub-pixel and is varied linearly with brightness of each the sub-pixels.

4. The active matrix display device as claimed in claim 1, wherein each the sub-pixels disposed have a symmetrical shape with respect to the central of each the pixels, and each the sub-pixels are symmetrically located with respect to the symmetric center of each the pixels.

5. The active matrix display device as claimed in claim 1, wherein the sub-pixels comprise a first sub-pixel and a second sub-pixel and the areas of first sub-pixel and the second sub-pixel are different,
the first sub-pixel comprising:
a first SRAM for memorizing a first input digital data of the input digital data for the first sub-pixel;
a first digital to analog converter circuit for converting the first input digital data to a first displaying analog data for the first sub-pixel; and
a first liquid crystal display element displaying gray scale by using the first displaying analog data to determine gray scale;
the second sub-pixel comprising:
a second SRAM for memorizing a second input digital data of the input digital data for the second sub-pixel;
a second digital to analog converter circuit for converting the second input digital data to a second displaying analog data for the second sub-pixel; and
a second liquid crystal display element displaying gray scale by using the second displaying analog data to determine gray scale.

6. The active matrix display device as claimed in claim 5, wherein the first sub-pixel comprises four gray scales which varied linearly with the brightness of the first sub-pixel, and the second sub-pixel comprises four gray scales which varied linearly with brightness of the second sub-pixel, wherein the area ratio between the first sub-pixel and the second sub-pixel is set to 1:4.

7. The active matrix display device as claimed in claim 5, wherein the shape of the first sub-pixel is a quadrangle, the shape of the second sub-pixel is surrounding the first sub-pixel, and the centers of the first and second sub-pixels are disposed at the central region of the pixel.

8. The active matrix display device as claimed in claim 5, wherein the first and the second liquid crystal display elements are reflective liquid crystal display elements with reflectors for reflecting external light.

9. An electronic apparatus, comprising any active matrix display device as claimed in claim 1.

10. A display circuit for an active matrix display device with a plurality of pixels arranged as an array, each pixel divided into different areas of a plurality of sub-pixels, comprising:
a multi-bit memory disposed in the sub-pixels to memorize an input digital data with over two bits to served as an gray gradient information for displaying gray scale of each the sub-pixels; and
a digital to analog converter circuit for converting the input digital data memorized in the multi-bit memory to an analog data for displaying gray scale of each the sub-pixels.

11. A method of displaying images for an active matrix display device with a plurality of pixels arranged as an array, each pixel divided into different areas of a plurality of sub-pixels, comprising:
inputting an input digital data with over two bits to serve as an gray gradient information for displaying gray scale of each the sub-pixels;
converting the input digital data to analog data for displaying gray scale of each the sub-pixels; and
displaying gray scale of each the sub-pixels in accordance with the analog data determining gray scales of each the sub-pixel.
